(19) United States
(12) Patent Application Publication
(10) Pub. No.: US 2018/0173785 A1
(43) Pub. Date: Jun. 21, 2018

(54) DYNAMIC FAST PERCENTILER

(71) Applicant: Microsoft Technology Licensing, LLC, Redmond, WA (US)

(72) Inventors: Harsh Satyanarayan Dangayach, Sammamish, WA (US); Matthew Christopher Kuzior, Redmond, WA (US); Radhika Garg, Redmond, WA (US)

(73) Assignee: Microsoft Technology Licensing, LLC, Redmond, WA (US)

(21) Appl. No.: 15/382,514

(22) Filed: Dec. 16, 2016

(51) Int. Cl. G06F 17/30

(52) U.S. Cl. CPC G06F 17/30598; G06F 17/30424

(57) ABSTRACT

Determination of a value of a percentile for a large or live data set with reduced expenditure of computing resources is provided herein. The processing resources and storage resources needed to calculate percentiles for the data set are reduced by breaking the data set into buckets that retain a number of data points and the summed values of those data points in association with various filtering criteria. In response to a user request for the value of a percentile, a bucket is determined in which the percentile would reside, and a curve is developed to fit the values represented by that bucket. The curve is then used to determine and return an approximation of the value for the percentile.

### BACKGROUND

When analyzing data, especially when dealing with a large number of data points or output signals, statistical functions are often used to represent the data set as a whole or provide insights into the data set. Some statistical functions are relatively simple to calculate dynamically for a growing or changing data set (e.g., live-collected data), while others are processor intensive. For example, calculating a percentile may involve sorting all of the data points of a data set based on the relative magnitudes of their values, which requires storing all of the data points, and a computationally expensive sort operation (e.g., bubble sort, heap sort, merge sort) to organize those data points, which is complicated by the addition of new data points to the data set.

### SUMMARY

This summary is provided to introduce a selection of concepts in a simplified form that are further described below in the Detailed Description section. This summary is not intended to identify all key or essential features of the claimed subject matter, nor is it intended as an aid in determining the scope of the claimed subject matter.

Systems and methods are discussed herein to reduce the processing and storage resources needed to provide for the dynamic determination of percentiles of live-collected data. A computing device is configured to decentralize the percentile calculations based on dynamically chosen pivot points in the data set into a series of less-intensive calculations that may be scaled according to the size of the data set. Collected data are sorted into buckets based on various user-selected pivots related to the data, and the counts of data points collected in the buckets are used to select a given bucket to provide the percentile value. A curve is developed to describe the behavior of the data stored in the given bucket, and the value for desired percentile is returned to the user based on that curve.

Examples are implemented as a computer process, a computing system, or as an article of manufacture such as a device, computer program product, or computer readable medium. According to an aspect, the computer program product is a computer storage medium readable by a computer system and encoding a computer program comprising instructions for executing a computer process.

The details of one or more aspects are set forth in the accompanying drawings and description below. Other features and advantages will be apparent from a reading of the following detailed description and a review of the associated drawings. It is to be understood that the following detailed description is explanatory only and is not restrictive of the claims.

### BRIEF DESCRIPTION OF THE DRAWINGS

The accompanying drawings, which are incorporated in and constitute a part of this disclosure, illustrate various aspects. In the drawings:

FIG. 1 illustrates an example operating environment in which the present disclosure may be practiced;

FIG. 2 is a flow chart showing general stages involved in an example method for interactively calculating percentiles in a dynamic data set with reduced expenditure of processing resources;

FIG. 3 is a block diagram illustrating example physical components of a computing device;

FIGS. 4A and 4B are block diagrams of a mobile computing device; and

FIG. 5 is a block diagram of a distributed computing system.

### DETAILED DESCRIPTION

The following detailed description refers to the accompanying drawings. Wherever possible, the same reference numbers are used in the drawings and the following description refers to the same or similar elements. While examples may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description is not limiting, but instead, the proper scope is defined by the appended claims. Examples may take the form of a hardware implementation, or an entirely software implementation, or an implementation combining software and hardware aspects. The following detailed description is, therefore, not to be taken in a limiting sense.

Examples given herein, for ease of explanation, will be rounded to the nearest integer value, although one of ordinary skill in the art will appreciate that the detailed description is applicable to other number sets, including real and imaginary values. Variables discussed in the examples herein are provided in italic text and unless stated otherwise, a variable using a given character in one example is unrelated to a variable in another example using the same given character.

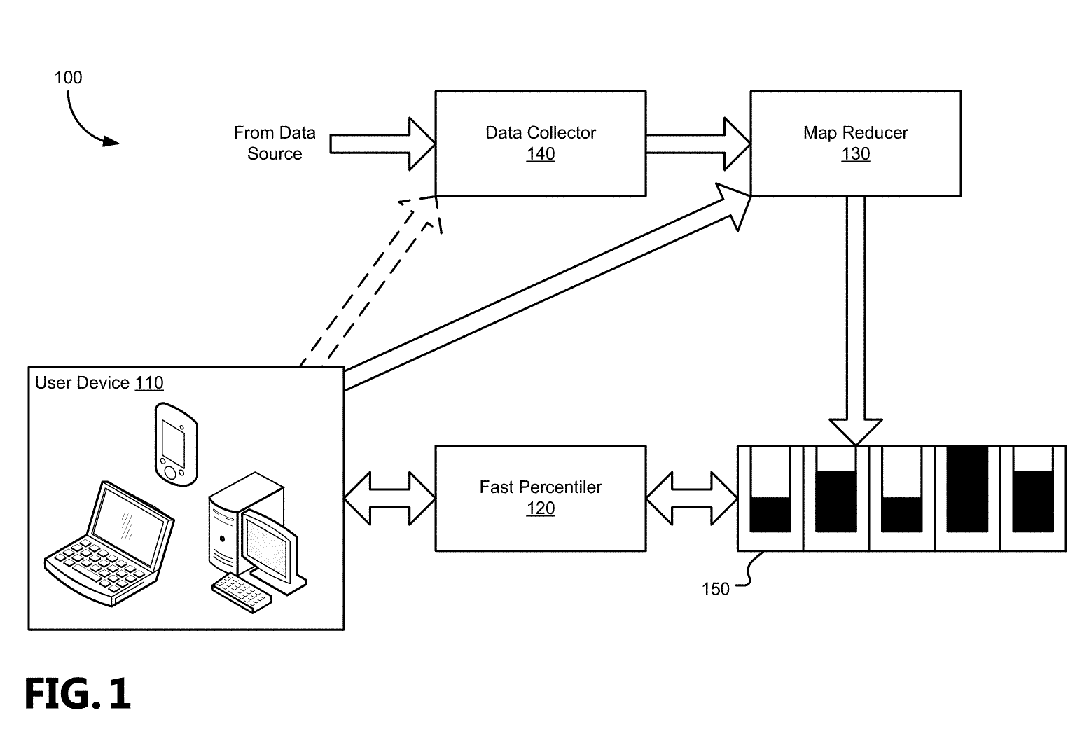

FIG. 1 illustrates an example operating environment 100 in which the present disclosure may be practiced. As shown, user device 110 is in communication with a fast percentiler 120 and a map reducer 130 to request and receive data regarding the value of a data set at a given percentile of that data set. The map reducer 130 processes data points received from a data collector 140 (in communication with one or more data sources) into a plurality of buckets 150 based on common features of those data points and their values. The fast percentiler 120 examines those buckets 150 to locate one bucket containing the desired percentile of the data set, and interpolates the values of the bucket 150 to produce queried-for value, which is returned to the user device 110.

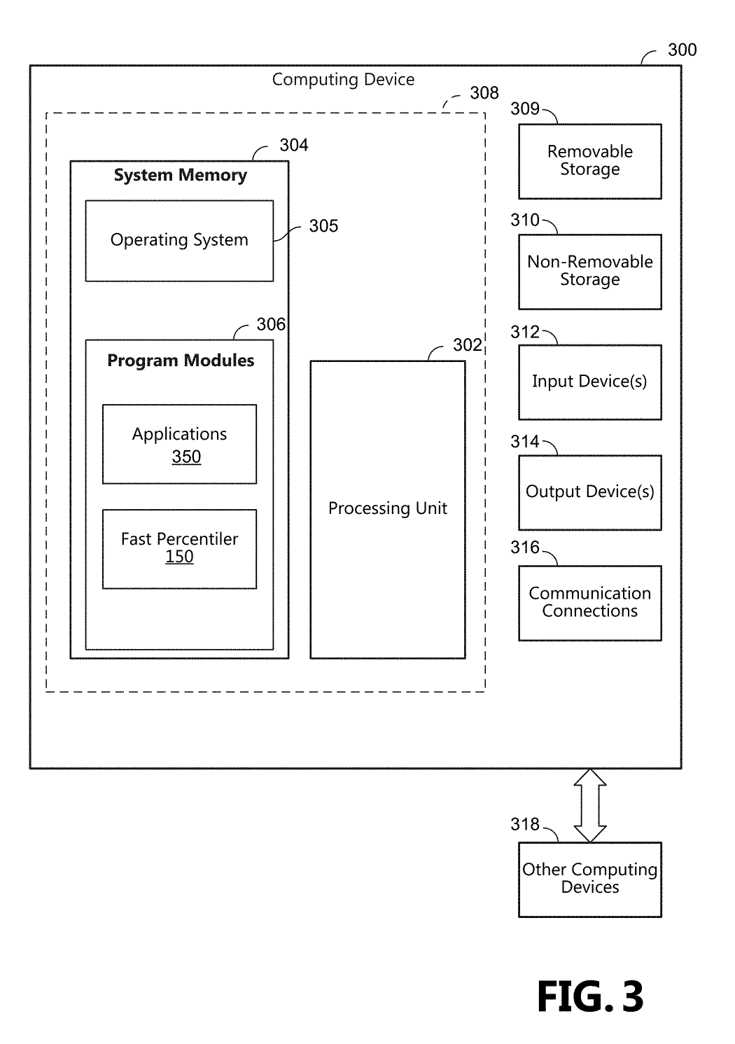

The user device 110, fast percentiler 120, map reducer 130, and data collector 140 are illustrative of a multitude of computing systems including, without limitation, desktop computer systems, wired and wireless computing systems, mobile computing systems (e.g., mobile telephones, netbooks, tablet or slate type computers, notebook computers, and laptop computers), hand-held devices, multiprocessor systems, microprocessor-based or programmable consumer electronics, minicomputers, printers, and mainframe computers. The hardware of these computing systems is discussed in greater detail in regard to FIGS. 3-5.

While the user device 110, fast percentiler 120, map reducer 130, and data collector 140 are shown remotely from one another for illustrative purposes, it should be noted that several configurations of one or more of these devices hosted locally to another illustrated device are possible, and each illustrated device may represent multiple instances of that device. For example, one or more of the fast percentiler 120, map reducer 130, and data collector 140 may be components of the user device 110. Various servers and intermediaries familiar to those of ordinary skill in the art may lie between the component systems illustrated in FIG. 1 to route the communications between those systems, which are not illustrated so as not to distract from the novel aspects of the present disclosure.

User devices 110 are operated by users, who may be humans or automated systems (e.g., “bots”). In various aspects, the user device 110, fast percentiler 120, map reducer 130, and data collector 140 may be accessed by a user or each other locally and/or by a network, which may include the Internet, a Local Area Network (LAN), a private distributed network for an entity (e.g., a company, a university, a government agency), a wireless ad hoc network, a Virtual Private Network (VPN) or other direct data link (e.g., Bluetooth connection, a direct wired link). The user device 110 is accessed by a user to request a value corresponding to a percentile of a data set. For example, a user may request the value of the nth percentile of the data set, for which n% of the data set is less than the value. In various aspects, the request is made in a thin client running on the user device 110 in conjunction with a client running on a remote server. In other aspects, the request is made on the user device 110 as a thick client accessing data to be processed by the user device 110. In various aspects, the user device 110 will communicate data collection, structuring, and filtering criteria to the fast percentiler 120, map reducer 130, and data collector 140 to refine the percentile queries of the data set examined.

The data collector 140 is configured to gather data from one or more data sources. In various aspects, the data collector 140 is part of a distributed system gathering “big data”, comprising a myriad of data points from a myriad of sources in real time. In additional aspects, the data points collected by the data collector 140 are live, with the values of the data points changing over time or new data points being gathered as time progresses. For example, the data collector 140 may be in communication with a series of network probes measuring packet throughput of a network at a given time at given locations in the network, and updating the data point values as time progresses. In another example, network response times (latency) are measured as individual network requests are handled, adding to the data set.

In various aspects, the data collector 140 is further configured to associate various pivot tags with the data points. In other aspects, the map reducer 130 is configured to associate the pivot tags with the data points. For example, the data source from which the data point was collected (e.g., network probe A, B, or C), the time at which the data point was collected (e.g., at time HH:MM:SS, on day D), or whether the value of the data point falls within a given range (e.g., above/below threshold), may be associated with the data points as pivot tags. In another example, a type of action that led to the creation/collection of the data point may be associated with the data points as pivot tags (e.g., a request for content item A from user B resulted in a network latency value of C).

The map reducer 130 is configured to receive a selected pivot from the user device 110 by which to filter the data set and to produce the plurality of buckets 150 from data points that include pivot tags that satisfy the selected pivot. The buckets 150, in some aspects, filter the data set into logarithmically divided sections based on the values of the data points. In other aspects, linear divisions of the values may be used. The values used to set the boundaries of the buckets are referred to herein as the floor value (the minimum value) and the ceiling value (the maximum value). The buckets 150 each specify distinct value ranges; avoiding overlap between the values filtered into each bucket 150. In various aspects, an initial bucket 150 (having the lowest value range) may have a floor value set to a lower measurement limit, an asymptote, or an open floor value corresponding to the lowest value observed in the data set. Similarly, in various aspects, a terminal bucket 150 (having the highest value range) may have a ceiling value set to an upper measurement limit, an asymptote, or an open ceiling value corresponding to the highest value observed in the data set.

The buckets 150 provide for reduced storage space requirements compared to percentile calculation solutions that require sorted lists of data points. Each bucket 150 stores a number of data points that have been filtered into its value range, a running average (mean) for the values stored in the bucket 150, the floor value, the ceiling value, and the pivots that define which data points are stored in the plurality of buckets 150 to which the specific bucket 150 belongs. When data are collected from a live data source, new data points may be added to a particular existing bucket 150 based on its value and the pivot tags associated with the new data point, such that the count for the particular bucket is incremented, and the sum of the values it holds has the new data point's value added thereto.

As will be apparent, the size of the value range may be adjusted by a user to create more or fewer buckets 150 in a given collection of buckets 150, which allows for greater accuracy with more buckets 150 for the tradeoff of additional storage space. The compressed data set segments stored in the buckets 150 reduce the storage space requirements to calculate percentiles of the data set compared to lists of the data points that are sorted according to their relative values. Additionally, as sort operations are computationally intensive, building the buckets 150 is less computationally expensive than sorting a list of data points, especially when the data set is large (e.g., “big data” applications) or live, and new data points are being added to the data set as the calculation is being performed.

The fast percentiler 120 is configured to receive a queried percentile for a data set from the user device 110 and return the value for the queried percentile to the user device 110. To determine this value, the fast percentiler 120 is further configured to identify a given bucket 150 of the plurality of buckets 150 produced and filled by the map reducer 130 in which the queried percentile resides, and interpolate that value from the characteristics of the given bucket 150. The given bucket 150 is selected from the plurality of buckets 150 as the first bucket 150 from the initial bucket 150 that includes a running total of the count of data points that exceeds the queried-for percentile [count(bucket₁₋ₙ)/count(bucketₐₗₗ)>percentile]. The selected bucket 150 is then interpolated based on its floor value, ceiling value, and average (mean) value to develop a curve that describes the behavior of the data points stored in the bucket 150. In various aspects, the curve developed for the bucket 150 is a linear, polynomial, or spline formula that approximates the behavior of the data points. The curve formula is then used to produce the value for the queried-for percentile, which is returned to the user device 110.

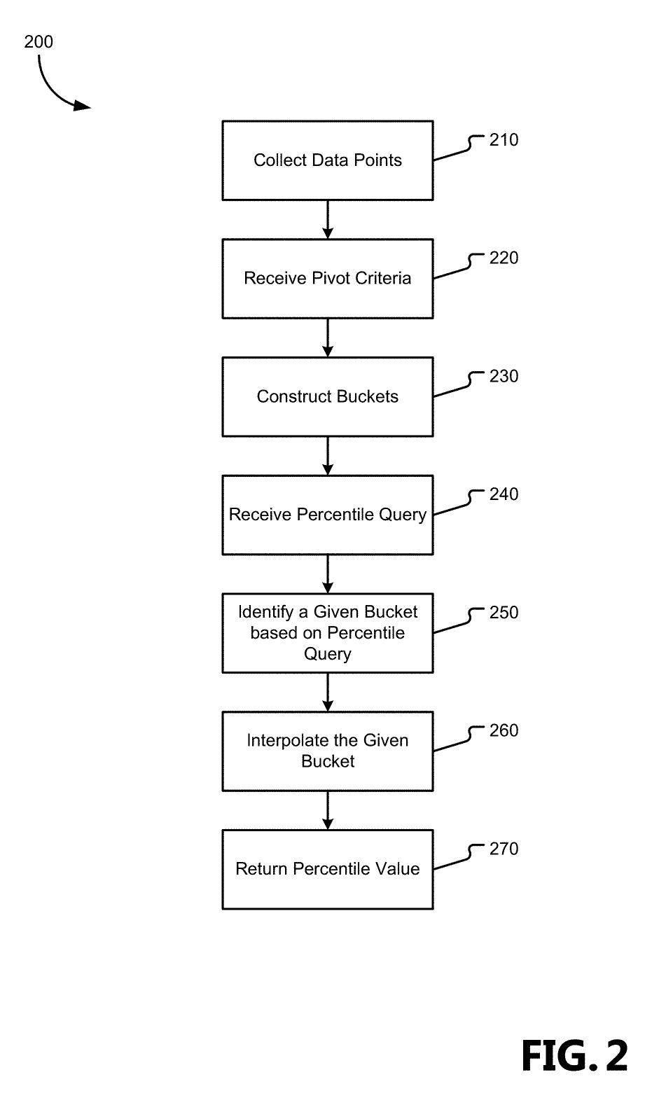

FIG. 2 is a flow chart showing general stages involved in an example method 200 for interactively calculating percentiles in a dynamic data set with reduced expenditure of processing resources. Method 200 begins with OPERATION 210, where data points for the data set are collected. In various aspects, the values of the data points are associated with various metadata to be used as pivot tags by which the data points may be filtered. Examples, of pivot tags include, but are not limited to: a source of the data point, a time at which the data point was collected, a reason why the data point was generated (e.g., who requested it, a request type), a value range for the data point, etc.

Pivot criteria are received at OPERATION 220 to filter which data points from the data set are examined based on their associated pivot tags satisfying the pivot(s) specified. In a first example, a pivot criteria may specify that the data set is to be filtered such that data points that are gathered from source A are excluded from consideration or only data points from source A are considered. In a second example, the pivot criteria may specify that data points gathered between time B and time C are to be considered. In a third example, the pivot criteria may specify that data points gathered from source A between times B and C are to be considered. One or ordinary skill in the art will appreciated that various combinations of pivot criteria are contemplated by the present disclosure to enable a user to filter the data set to a desired subset thereof having metadata criteria that satisfy one or more pivots specified by the user.

Proceeding to OPERATION 230, the buckets 150 are constructed from the filtered data points. In various aspects, the buckets 150 are constructed based on value ranges, which may be scaled linearly, logarithmically or according to another scale, such as user-defined formula, depending on the application and the data set. For example, in a logarithmically ranged plurality of buckets 150, a first bucket 150 having a value range of 0 to 1 will accept all data points whose values are between 0 and 1, while a second bucket 150 having a value range of 1 to 10 will accept all data points whose values are between 1 and 10. For purposes of the present disclosure, the lower bound of a given bucket 150 is referred to as a floor value, while the upper bound is referred to as a ceiling value. In various aspects, an initial bucket 150 (being the bucket 150 with the smallest floor value of the plurality of buckets 150) may be set to have a floor value equal to a lower measurement terminus (e.g., zero, negative infinite, an asymptote, a lower end of a measurement scale) or the lowest value seen in the data set. Similarly, a terminal bucket 150 (being the bucket 150 with the largest ceiling value of the plurality of buckets 150) may be set to have a ceiling value equal to an upper measurement terminus (e.g., zero, positive infinite, an asymptote, an upper end of a measurement scale) or the highest value seen in the data set.

Each bucket 150 may be stored in memory as a compressed form of the data points that it represents; reducing storage requirements for the computing devices used to calculate percentiles on the data set. In various aspects, the buckets 150, when stored, include a count of the number of data points that have been included therein, and a sum of the values of those data points. These data enable the bucket 150 to maintain a running average (mean) so that as new data points are added to the bucket 150, the average may be accurately provided. Additionally, in some aspects, the ceiling values and floor values for the buckets 150, as well as the pivot criteria used to define the data points to include in a given bucket 150 are associated with the stored buckets 150.

At OPERATION 240 a percentile query is received. The percentile query requests the value of the data set that corresponds to a given percentile. For example, a query of the set of integers from 1 to 100 for the 85th percentile will return the value of 85. Because the data set in question may be very large (e.g., for “big data” analysis) and/or live, the buckets 150 enable a faster determination of the percentile value with a lower expenditure of processing resources than required to sort and extract a value from the data set.

The given bucket 150 in which the percentile resides is identified at OPERATION 250. When identifying the given bucket 150, the count for data points in each bucket relative to the total count of data points is used to form a running count, starting with the initial bucket 150. The first bucket 150 for which the running count exceeds the queried-for percentile is then selected as the given bucket 150.

For example, with four buckets 150, each with twenty-five data points, the 60th percentile would be in the third bucket 150, and the running count would be first bucket count plus second bucket count plus third bucket count divided by the total count [(25+25+25)/100>0.60], and the third bucket 150 would be the first to exceed 60%. If instead, the queried-for percentile in the above example were the 24th percentile, the first bucket 150 would be the given bucket 150 based on its count divided by the total count [25/100>0.24] exceeding the queried-for percentile. In a further example, if the four buckets 150 contained forty, thirty, twenty, and ten data points (from initial to terminal buckets 150 respectively), the given bucket 150 would be selected as the second bucket 150 based on the added counts of the first and second buckets 150 divided by the total count exceeding 60% of the total count [(40+30)/100>0.60].

Proceeding to OPERATION 260, the given bucket 150 is interpolated to produce the percentile value. A curve is developed to represent the range of values represented by the given bucket 150. In various aspects, the floor value, ceiling value, and average (mean) value of the given bucket 150 are used in developing the interpolated curve's formula, and a linear, polynomial, or spline interpolation may be used in different aspects. In a first example, if the equation [y=ax³+bx²+c] were selected for the curve formula, the variables a, b, and c are solved for using the x/y pairs of (0, floor value), (1, ceiling value), and the integral of the curve equation from zero to one [∫₀¹(ax³+bx²+c)] set equal to the average value. In a second example, if the equation [y=ax²−bx+c] were selected for the curve formula, the variables a, b, and c are solved for using the x/y pairs of (0, floor value), (1, ceiling value), and the integral of the curve equation from zero to one [∫₀¹(ax²−bx+c)] set equal to the average value.

Once the variables for the curve formula are determined, the queried-for percentile is used to develop an x value, which is fed into the curve formula to produce the value for the queried percentile as the y value. The x value corresponds to the position on the curve representative of the percentile value. Using the four buckets 150 of twenty-five data points of the integers 1 to 100 as an example, if the percentile queried for were the 60th percentile, which should return a value of sixty for the data set, the value of the 60th percentile of the third bucket 150 (including values for fifty-one to seventy-five) is sixty-five; the percentile must be adjusted to match the bucket 150 and its position in the plurality of buckets 150 to return the correct value for the percentile queried. In various aspects, the x value for the given bucket 150 is determined according to the formula: [x=percentile_{original}−(countₚᵣᵢₒᵣ_{_}_{buckets}÷countₐₗₗ_{_}_{buckets})].

At OPERATION 270 the percentile value is returned to the user device 110. In various aspects, the user device 110 may use the percentile value in a visualization of the data set, request a value for a second percentile using the same buckets 150 (which may be in a particular bucket 150 other than or the same as the given bucket 150), or request a different set of buckets 150 by setting different pivot criteria. Method 200 may then conclude or repeat per user instructions.

While implementations have been described in the general context of program modules that execute in conjunction with an application program that runs on an operating system on a computer, those skilled in the art will recognize that aspects may also be implemented in combination with other program modules. Generally, program modules include routines, programs, components, data structures, and other types of structures that perform particular tasks or implement particular abstract data types.

The aspects and functionalities described herein may operate via a multitude of computing systems including, without limitation, desktop computer systems, wired and wireless computing systems, mobile computing systems (e.g., mobile telephones, netbooks, tablet or slate type computers, notebook computers, and laptop computers), hand-held devices, multiprocessor systems, microprocessor-based or programmable consumer electronics, minicomputers, and mainframe computers.

In addition, according to an aspect, the aspects and functionalities described herein operate over distributed systems (e.g., cloud-based computing systems), where application functionality, memory, data storage and retrieval and various processing functions are operated remotely from each other over a distributed computing network, such as the Internet or an intranet. According to an aspect, user interfaces and information of various types are displayed via on-board computing device displays or via remote display units associated with one or more computing devices. For example, user interfaces and information of various types are displayed and interacted with on a wall surface onto which user interfaces and information of various types are projected. Interaction with the multitude of computing systems with which implementations are practiced include, keystroke entry, touch screen entry, voice or other audio entry, gesture entry where an associated computing device is equipped with detection (e.g., camera) functionality for capturing and interpreting user gestures for controlling the functionality of the computing device, and the like.

FIGS. 3-5 and the associated descriptions provide a discussion of a variety of operating environments in which examples are practiced. However, the devices and systems illustrated and discussed with respect to FIGS. 3-5 are for purposes of example and illustration and are not limiting of a vast number of computing device configurations that are utilized for practicing aspects, described herein.

FIG. 3 is a block diagram illustrating physical components (i.e., hardware) of a computing device 300 with which examples of the present disclosure may be practiced. In a basic configuration, the computing device 300 includes at least one processing unit 302 and a system memory 304. According to an aspect, depending on the configuration and type of computing device, the system memory 304 comprises, but is not limited to, volatile storage (e.g., random access memory), non-volatile storage (e.g., read-only memory), flash memory, or any combination of such memories. According to an aspect, the system memory 304 includes an operating system 305 and one or more program modules 306 suitable for running software applications 350. According to an aspect, the system memory 304 includes fast percentiler 120. The operating system 305, for example, is suitable for controlling the operation of the computing device 300. Furthermore, aspects are practiced in conjunction with a graphics library, other operating systems, or any other application program, and are not limited to any particular application or system. This basic configuration is illustrated in FIG. 3 by those components within a dashed line 308. According to an aspect, the computing device 300 has additional features or functionality. For example, according to an aspect, the computing device 300 includes additional data storage devices (removable and/or non-removable) such as, for example, magnetic disks, optical disks, or tape. Such additional storage is illustrated in FIG. 3 by a removable storage device 309 and a non-removable storage device 310.

As stated above, according to an aspect, a number of program modules and data files are stored in the system memory 304. While executing on the processing unit 302, the program modules 306 (e.g., fast percentiler 120) perform processes including, but not limited to, one or more of the stages of the method 200 illustrated in FIG. 2. According to an aspect, other program modules are used in accordance with examples and include applications such as electronic mail and contacts applications, word processing applications, spreadsheet applications, database applications, slide presentation applications, drawing or computer-aided application programs, etc.

According to an aspect, the computing device 300 has one or more input device(s) 312 such as a keyboard, a mouse, a pen, a sound input device, a touch input device, etc. The output device(s) 314 such as a display, speakers, a printer, etc. are also included according to an aspect. The aforementioned devices are examples and others may be used. According to an aspect, the computing device 300 includes one or more communication connections 316 allowing communications with other computing devices 318. Examples of suitable communication connections 316 include, but are not limited to, radio frequency (RF) transmitter, receiver, and/or transceiver circuitry; universal serial bus (USB), parallel, and/or serial ports.

The term computer readable media, as used herein, includes computer storage media. Computer storage media include volatile and nonvolatile, removable and non-removable media implemented in any method or technology for storage of information, such as computer readable instructions, data structures, or program modules. The system memory 304, the removable storage device 309, and the non-removable storage device 310 are all computer storage media examples (i.e., memory storage.) According to an aspect, computer storage media include RAM, ROM, electrically erasable programmable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 300. According to an aspect, any such computer storage media is part of the computing device 300. Computer storage media do not include a carrier wave or other propagated data signal.

According to an aspect, communication media are embodied by computer readable instructions, data structures, program modules, or other data in a modulated data signal, such as a carrier wave or other transport mechanism, and include any information delivery media. According to an aspect, the term “modulated data signal” describes a signal that has one or more characteristics set or changed in such a manner as to encode information in the signal. By way of example, and not limitation, communication media include wired media such as a wired network or direct-wired connection, and wireless media such as acoustic, radio frequency (RF), infrared, and other wireless media.

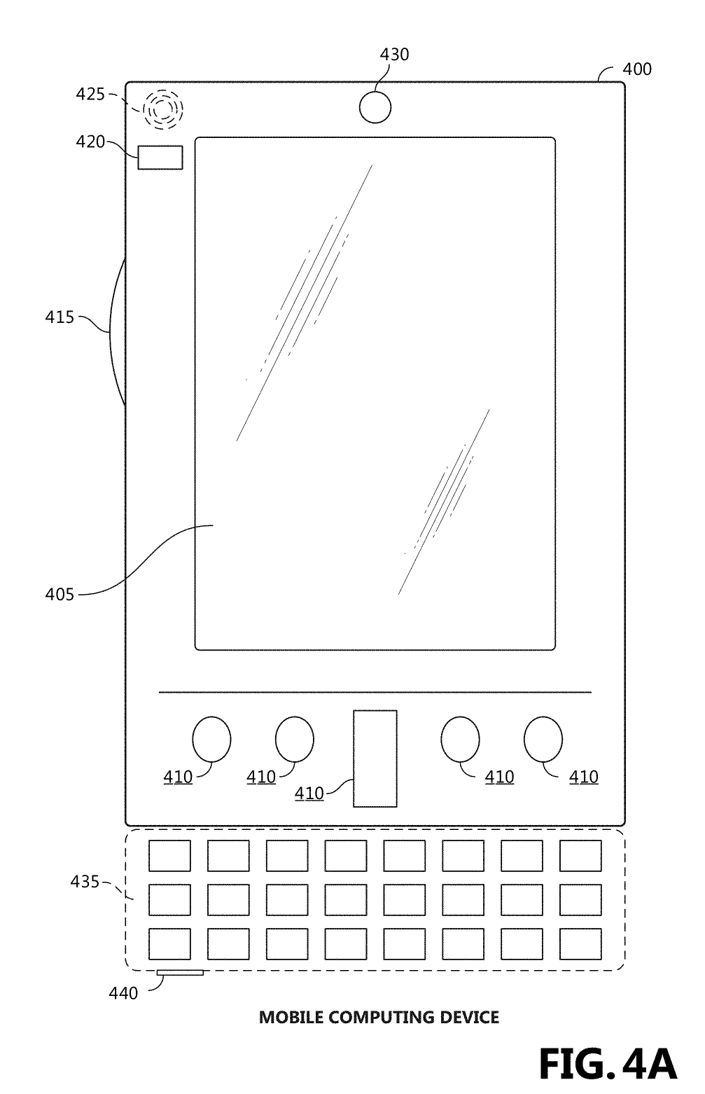

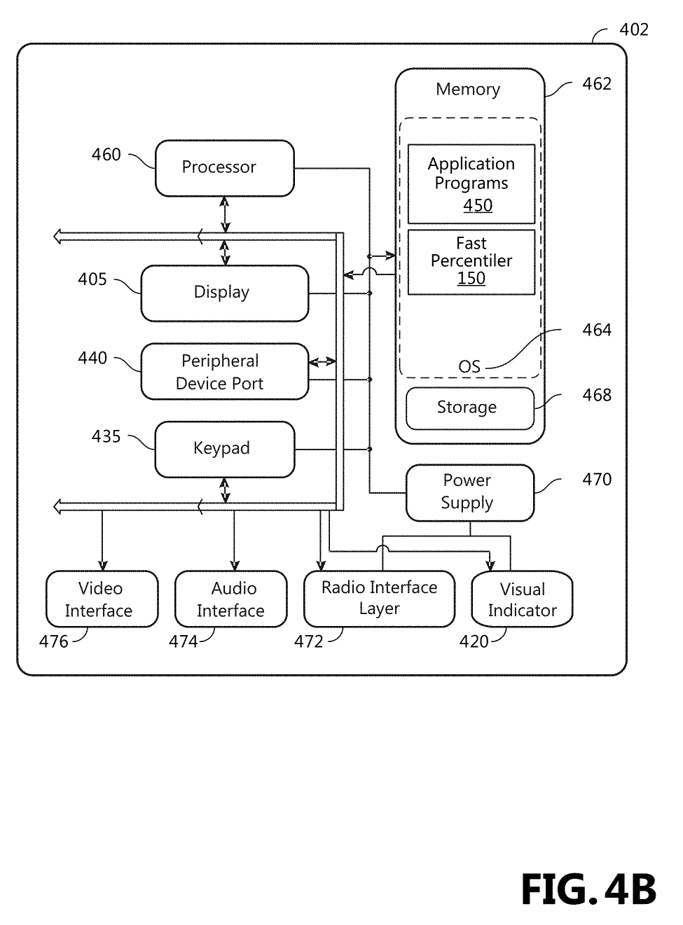

FIGS. 4A and 4B illustrate a mobile computing device 400, for example, a mobile telephone, a smart phone, a tablet personal computer, a laptop computer, and the like, with which aspects may be practiced. With reference to FIG. 4A, an example of a mobile computing device 400 for implementing the aspects is illustrated. In a basic configuration, the mobile computing device 400 is a handheld computer having both input elements and output elements. The mobile computing device 400 typically includes a display 405 and one or more input buttons 410 that allow the user to enter information into the mobile computing device 400. According to an aspect, the display 405 of the mobile computing device 400 functions as an input device (e.g., a touch screen display). If included, an optional side input element 415 allows further user input. According to an aspect, the side input element 415 is a rotary switch, a button, or any other type of manual input element. In alternative examples, mobile computing device 400 incorporates more or fewer input elements. For example, the display 405 may not be a touch screen in some examples. In alternative examples, the mobile computing device 400 is a portable phone system, such as a cellular phone. According to an aspect, the mobile computing device 400 includes an optional keypad 435. According to an aspect, the optional keypad 435 is a physical keypad. According to another aspect, the optional keypad 435 is a “soft” keypad generated on the touch screen display. In various aspects, the output elements include the display 405 for showing a graphical user interface (GUI), a visual indicator 420 (e.g., a light emitting diode), and/or an audio transducer 425 (e.g., a speaker). In some examples, the mobile computing device 400 incorporates a vibration transducer for providing the user with tactile feedback. In yet another example, the mobile computing device 400 incorporates input and/or output ports, such as an audio input (e.g., a microphone jack), an audio output (e.g., a headphone jack), and a video output (e.g., a HDMI port) for sending signals to or receiving signals from an external device. In yet another example, the mobile computing device 400 incorporates peripheral device port 440, such as an audio input (e.g., a microphone jack), an audio output (e.g., a headphone jack), and a video output (e.g., a HDMI port) for sending signals to or receiving signals from an external device.

FIG. 4B is a block diagram illustrating the architecture of one example of a mobile computing device. That is, the mobile computing device 400 incorporates a system (i.e., an architecture) 402 to implement some examples. In one example, the system 402 is implemented as a “smart phone” capable of running one or more applications (e.g., browser, e-mail, calendaring, contact managers, messaging clients, games, and media clients/players). In some examples, the system 402 is integrated as a computing device, such as an integrated personal digital assistant (PDA) and wireless phone.

According to an aspect, one or more application programs 450 are loaded into the memory 462 and run on or in association with the operating system 464. Examples of the application programs include phone dialer programs, e-mail programs, personal information management (PIM) programs, word processing programs, spreadsheet programs, Internet browser programs, messaging programs, and so forth. According to an aspect, the fast percentiler 120 is loaded into memory 462. The system 402 also includes a non-volatile storage area 468 within the memory 462. The non-volatile storage area 468 is used to store persistent information that should not be lost if the system 402 is powered down. The application programs 450 may use and store information in the non-volatile storage area 468, such as e-mail or other messages used by an e-mail application, and the like. A synchronization application (not shown) also resides on the system 402 and is programmed to interact with a corresponding synchronization application resident on a host computer to keep the information stored in the non-volatile storage area 468 synchronized with corresponding information stored at the host computer. As should be appreciated, other applications may be loaded into the memory 462 and run on the mobile computing device 400.

According to an aspect, the system 402 has a power supply 470, which is implemented as one or more batteries. According to an aspect, the power supply 470 further includes an external power source, such as an AC adapter or a powered docking cradle that supplements or recharges the batteries.

According to an aspect, the system 402 includes a radio 472 that performs the function of transmitting and receiving radio frequency communications. The radio 472 facilitates wireless connectivity between the system 402 and the “outside world,” via a communications carrier or service provider. Transmissions to and from the radio 472 are conducted under control of the operating system 464. In other words, communications received by the radio 472 may be disseminated to the application programs 450 via the operating system 464, and vice versa.

According to an aspect, the visual indicator 420 is used to provide visual notifications and/or an audio interface 474 is used for producing audible notifications via the audio transducer 425. In the illustrated example, the visual indicator 420 is a light emitting diode (LED) and the audio transducer 425 is a speaker. These devices may be directly coupled to the power supply 470 so that when activated, they remain on for a duration dictated by the notification mechanism even though the processor 460 and other components might shut down for conserving battery power. The LED may be programmed to remain on indefinitely until the user takes action to indicate the powered-on status of the device. The audio interface 474 is used to provide audible signals to and receive audible signals from the user. For example, in addition to being coupled to the audio transducer 425, the audio interface 474 may also be coupled to a microphone to receive audible input, such as to facilitate a telephone conversation. According to an aspect, the system 402 further includes a video interface 476 that enables an operation of an on-board camera 430 to record still images, video stream, and the like.

According to an aspect, a mobile computing device 400 implementing the system 402 has additional features or functionality. For example, the mobile computing device 400 includes additional data storage devices (removable and/or non-removable) such as, magnetic disks, optical disks, or tape. Such additional storage is illustrated in FIG. 4B by the non-volatile storage area 468.

According to an aspect, data/information generated or captured by the mobile computing device 400 and stored via the system 402 are stored locally on the mobile computing device 400, as described above. According to another aspect, the data are stored on any number of storage media that are accessible by the device via the radio 472 or via a wired connection between the mobile computing device 400 and a separate computing device associated with the mobile computing device 400, for example, a server computer in a distributed computing network, such as the Internet. As should be appreciated such data/information are accessible via the mobile computing device 400 via the radio 472 or via a distributed computing network. Similarly, according to an aspect, such data/information are readily transferred between computing devices for storage and use according to well-known data/information transfer and storage means, including electronic mail and collaborative data/information sharing systems.

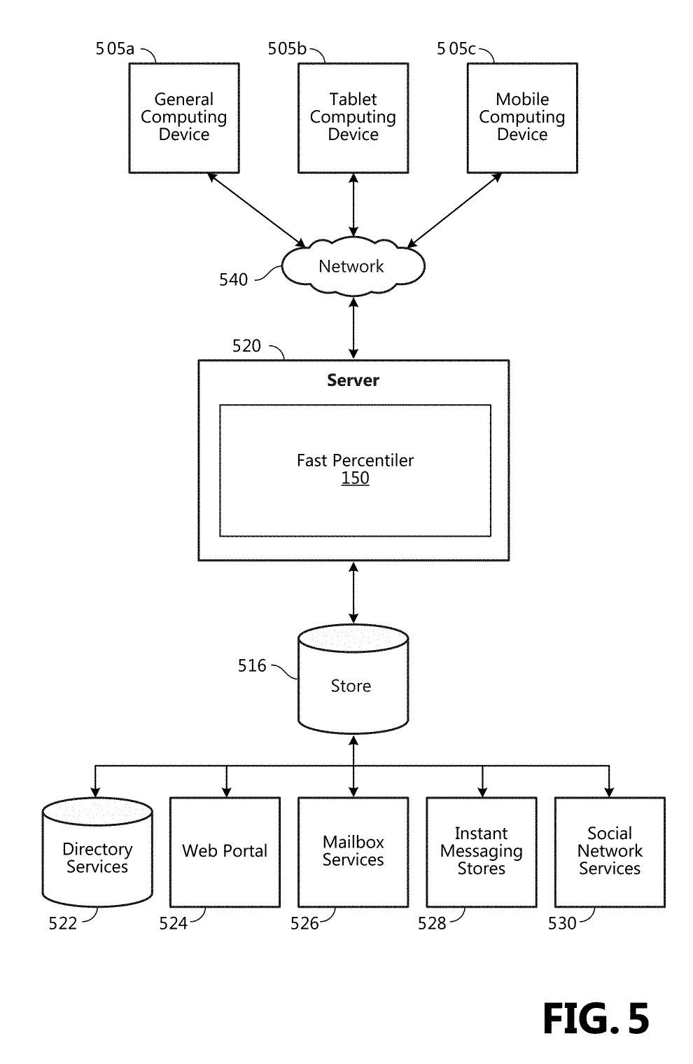

FIG. 5 illustrates one example of the architecture of a system for interactively calculating percentiles in a dynamic data set with reduced expenditure of processing resources as described above. Content developed, interacted with, or edited in association with the fast percentiler 120 is enabled to be stored in different communication channels or other storage types. For example, various documents may be stored using a directory service 522, a web portal 524, a mailbox service 526, an instant messaging store 528, or a social networking site 530. The fast percentiler 120 is operative to use any of these types of systems or the like for interactively calculating percentiles in a dynamic data set with reduced expenditure of processing resources, as described herein. According to an aspect, a server 520 provides the fast percentiler 120 to clients 505a,b,c. As one example, the server 520 is a web server providing the fast percentiler 120 over the web. The server 520 provides the fast percentiler 120 over the web to clients 505 through a network 540. By way of example, the client computing device is implemented and embodied in a personal computer 505a, a tablet computing device 505b or a mobile computing device 505c (e.g., a smart phone), or other computing device. Any of these examples of the client computing device are operable to obtain content from the store 516.

Implementations, for example, are described above with reference to block diagrams and/or operational illustrations of methods, systems, and computer program products according to aspects. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more examples provided in this application are not intended to limit or restrict the scope as claimed in any way. The aspects, examples, and details provided in this application are considered sufficient to convey possession and enable others to make and use the best mode. Implementations should not be construed as being limited to any aspect, example, or detail provided in this application. Regardless of whether shown and described in combination or separately, the various features (both structural and methodological) are intended to be selectively included or omitted to produce an example with a particular set of features. Having been provided with the description and illustration of the present application, one skilled in the art may envision variations, modifications, and alternate examples falling within the spirit of the broader aspects of the general inventive concept embodied in this application that do not depart from the broader scope.

We claim:

1. A method for reducing expenditures of processing resources when interactively calculating percentiles in a dynamic data set, comprising:
collecting data points from the dynamic data set, the data points including values and pivot tags;
receiving a pivot;
filtering the data points into buckets based on the pivot tags corresponding to the pivot;
counting a number of data points in each of the buckets;
receiving a percentile query, the percentile query identifying a percentile of the data set and requesting a queried value corresponding to the percentile in the data set;
identifying, based the number of data points for each of the buckets, a given bucket of the buckets in which the percentile of the data set resides;
identifying the queried value by interpolating the given bucket; and
returning the queried value.

2. The method of claim 1, wherein pivot tags include at least one of:
a data source;
a value range; and
a collection time.

3. The method of claim 1, further comprising:
storing each of the buckets on a computer readable storage medium, wherein each of the buckets is stored as a count of the number of data points and a sum of the data points;
receiving a new data point;
identifying, based on the pivot tags, a target bucket of the buckets in which to store the new data point;
incrementing the count of the target bucket; and
increasing the sum of the target bucket by the value of the new data point.

4. The method of claim 1, further comprising:
receiving a second pivot;
filtering the data points into new buckets based on the pivot tags corresponding to the second pivot;
counting a new number of data points in each of the new buckets;
identifying, based on the new number for each of the new buckets, a given new bucket of the new buckets in which the percentile of the data set resides;
identifying the queried value by interpolating the given new bucket; and
returning the queried value.

5. The method of claim 1, further comprising:
receiving a second percentile query, the second percentile query identifying a second percentile of the data set and requesting a second queried value corresponding to the second percentile in the data set;
identifying, based on the number of data points for each of the buckets, a particular bucket of the buckets in which the second percentile of the data set resides;
identifying the second queried value by interpolating the particular bucket; and
returning the second queried value.

6. The method of claim 1, wherein interpolating the given bucket comprises:
summing the values of the data points in the given bucket to produce a sum value;
identifying a floor value for the given bucket;
identifying a ceiling value for the given bucket;
calculating, based on the sum value and the number of data points mapped to the given bucket, an average value for the given bucket;
fitting the floor value, the ceiling value, and the average value to a curve; and
identifying the queried value from the curve based on the percentile of the data set.

7. The method of claim 1, wherein the given bucket is identified from the buckets by:
calculating, based on the number of data points for each of the buckets, a running total of data points from an initial bucket; and
selecting, as the given bucket, a first bucket from the initial bucket in which the running total exceeds the percentile value as a percentage of the number of data points for all of the buckets.

8. A computer readable storage device including instructions that when executed by a processor provide for reducing expenditures of processing resources when interactively calculating percentiles in a dynamic data set, the instructions comprising:
collecting data points from the dynamic data set, the data points including values and pivot tags;
receiving a pivot;
filtering the data points into buckets based on the pivot tags corresponding to the pivot;
counting a number of data points in each of the buckets;
summing the values of the data points in each of the buckets to produce a sum value for each of the buckets;
receiving a percentile query, the percentile query identifying a percentile of the data set and requesting a queried value corresponding to the percentile in the data set;
determining, based on the number of data points in each of the buckets, a given bucket of the buckets in which the percentile of the data set resides;
determining the queried value by interpolating the given bucket; and
returning the queried value.

9. The computer readable storage device of claim 8, wherein the instructions further comprise:
receiving a second pivot;
filtering the data points into new buckets based on the pivot tags corresponding to the second pivot;
counting a new number of data points in each of the new buckets;
determining, based on the new number of data points in each of the new buckets, a given new bucket of the new buckets in which the percentile in the data set resides;
determining the queried value by interpolating the given new bucket; and
returning the queried value.

10. The computer readable storage device of claim 8, wherein the instructions further comprise:
receiving a second percentile query, the second percentile query identifying a second percentile of the data set and requesting a second queried value corresponding to the second percentile in the data set;
determining, based on the number of data points in each of the buckets, a particular bucket of the buckets in which the second percentile of the data set resides;
determining the second queried value by interpolating the particular bucket; and
returning the second queried value.

11. The computer readable storage device of claim 8, wherein interpolating comprises:
summing the data points in the given bucket to produce a sum value;
identifying a floor value for the given bucket;
identifying a ceiling value for the given bucket;
calculating, based on the sum value and the number of data points, an average value for the given bucket;
fitting the floor value, the ceiling value, and the average value to a curve; and
identifying the queried value from the curve based on the percentile of the data set.

12. The computer readable storage device of claim 11, wherein the curve is one of:
a linear fit of the floor value, the ceiling value, and the average value;
a polynomial fit of the floor value, the ceiling value, and the average value; or
a spline fit of the floor value, the ceiling value, and the average value.

13. The computer readable storage device of claim 8, wherein each of the buckets is stored as a sum value of the data points mapped thereto and the number of the data points.

14. The computer readable storage device of claim 13, wherein in response to collecting a new data point for the dynamic data set:
identifying an appropriate bucket of the buckets based on the value of the new data point;
incrementing the count of the appropriate bucket; and
increasing the sum of the appropriate bucket by the value of the new data point.

15. A system for reducing expenditures of processing resources when interactively calculating percentiles in a dynamic data set, comprising:
a processor;
a memory storage device including instructions that when executed by the processor provide:
a data collector, configured to collect data points and associate pivot tags with the data points;
a map reducer, in communication with the data collector, configured to:
receive a selected pivot;
filter the data points from the data collector into a plurality of buckets based on the pivot tags and the selected pivot; and
provide a count of the data points filtered into each of the buckets of the plurality of buckets; and
a fast percentiler, in communication with the plurality of buckets and a user device, configured to:
receive a queried percentile of the data set from the user device;
identify a given bucket of the plurality of buckets in which the queried percentile resides based on the count for each of the buckets of the plurality of buckets;
interpolate a value for the queried percentile from the given bucket; and
transmit the value to the user device.

16. The system of claim 15, wherein the data collector collects the data points from a live data source, and wherein the map reducer is further configured to filter a new data point to a particular bucket of the plurality of buckets based on the value and pivot tags associated with the new data point, wherein the value of the new data point is added to a bucket value and the count of the data points filtered into the particular bucket is incremented.

17. The system of claim 15, wherein the map reducer is further configured to receive a new pivot, and in response:
filter the data points from the data collector into a new plurality of buckets based on the pivot tags and the new pivot; and
provide a count of the data points filtered into each of the buckets of the new plurality of buckets.

18. The system of claim 15, wherein the faster percentiler is further configured to receive a new queried percentile of the data set from the user device, and in response:
identify a particular bucket of the plurality of buckets in which the new queried percentile resides based on the count for each of the buckets of the plurality of buckets;
interpolate a new value for the new queried percentile from the particular bucket; and
transmit the new value to the user device

19. The system of claim 15, wherein the fast percentiler, to interpolate the value for the queried percentile from the given bucket is configured to:
sum the values of the data points filtered to the given bucket to produce a sum value;
identify a floor value for the given bucket;
identify a ceiling value for the given bucket;
calculate, based on the sum value and the count for the given bucket, an average value for the given bucket;
fit the floor value, the ceiling value, and the average value to a curve; and
identify the queried value from the curve based on the percentile of the data set.

20. The system of claim 15, wherein the given bucket is identified from the buckets by:
calculating, based on the count of data points for each of the buckets, a running total of data points from an initial bucket; and
selecting, as the given bucket, a first bucket from the initial bucket in which the running total exceeds the percentile value as a percentage of the count of data points for all of the buckets.
